(19) United States
(12) Patent Application Publication
(10) Pub. No.: US 2024/0376944 A1
(43) Pub. Date: Nov. 14, 2024

(54) Disc Brake for a Utility Vehicle

(71) Applicant: KNORR-BREMSE Systeme fuer Nutzfahrzeuge GmbH, Muenchen (DE)

(72) Inventors: Dimitrij HABERMANN, Stephansposching (DE); Alexander ASEN, Eichendorf (DE); Thomas EICHLER, Muenchen (DE)

(21) Appl. No.: 18/691,746

(22) PCT Filed: Aug. 8, 2022
(86) PCT No.: PCT/EP2022/072278

§ 371 Date: Mar. 13, 2024

(30) Foreign Application Priority Data
Sep. 14, 2021 (DE) 10 2021 123 775.5

(51) Int. Cl. F16D 65/00; F16D 55/00; F16D 55/227

(52) U.S. Cl. CPC F16D 65/0087; F16D 55/227; F16D 65/0037; F16D 65/0056; F16D 65/0068; F16D 2055/0008; F16D 2055/0016; F16D 2055/007

(57) ABSTRACT

A disc brake for a utility vehicle includes a brake caliper which straddles a brake disc and which is held displaceably on a stationary brake carrier by two guide bars, each guide bar having a guide bushing which is connected to the brake carrier by way of a screw that is screwed into a threaded hole of the brake carrier and which is held on the brake carrier for conjoint rotation therewith. The disc brake is designed in such a way that the end face of the guide bushing bearing against the brake carrier has a peripheral projection which is pressed against the associated surface of the brake carrier.

The invention relates to a disc brake for a utility vehicle.

The brake caliper of a disc brake of the type in question is held movably on a vehicle-mounted brake carrier, for which purpose guide bars are provided, said guide bars each consisting of a guide bushing and a screw, which is guided therein and is screwed into a threaded hole in the stationary, i.e. vehicle-mounted, brake carrier, usually into a brake carrier horn.

The respective guide bushing rests by means of an end face against the associated surface of the brake carrier, wherein a high-tensile screw that presses the guide bar against the brake carrier under a preload is used as a screw.

In many cases, use is made of brake carriers whose surface facing the guide bushings is provided with a coating that reduces the friction coefficient, e.g. made of zinc phosphate.

However, owing to the reduced frictional engagement between the guide bushing and the brake carrier, this increases the risk that the guide bushing will be twisted, and this can lead to a loss of the preloading force of the screw and ultimately to its loosening.

This results in a restriction to the operational and functional safety of the disc brake overall since the ultimate effect of the loosening of the screw fastening is a total failure of the brake. A disc brake is a component relevant to safety, and therefore this hazard presents an unacceptable situation.

To provide a remedy, DE 10 2013 109 673 A1 proposes to arrange a retention element in the form of two wedge lock washers between the guide bushing and the brake carrier, the circumferential wedge surfaces of the washers engaging in one another in the manner of toothing.

Although security against rotation is achieved by means of this design, it is only by the provision of additional components, namely said wedge lock washers, the procurement of which is associated with additional costs, something that runs counter to the constant effort to optimize costs.

The object on which the invention is based is to further develop a disc brake of the type in question in such a way that its functional and operational safety is improved with a low outlay in terms of design and manufacture.

This object is achieved by a disc brake having the features of the independent claims.

Fundamentally, the solution according to the invention of the object consists in increasing the surface pressure in the region of contact of the guide bushing with the brake carrier, that is to say with the associated brake carrier horn, resulting in an increase in the friction coefficient which prevents twisting of the guide bushing in an effective manner as long as the screw produces a corresponding contact pressure.

This frictional engagement is also present if the surface of the brake carrier is provided in the contact region with a coating, e.g. in the form of zinc phosphate, which, as described in the prior art, reduces the friction coefficient.

According to an advantageous development of the invention, the guide bushing, or at least the projection according to the invention, consists of a harder material than the brake carrier, wherein either the guide bushing as a whole is manufactured from a harder steel or the projection is harder due to appropriate treatment.

It is contemplated to provide the contact region between the guide bushing and the brake carrier with, for example, a paste that increases the friction coefficient or with a coating that hardens, the latter in the contact region of the projection, optionally also in the adjoining region-which forms a contact surface-of the end face of the guide bushing. As another alternative to increasing the friction coefficient, an insert that increases the friction coefficient can be provided on the end face of the guide bushing.

In respect of its cross section, the projection itself can take different configurations, e.g. as a sharp-edged ridge with a triangular cross section or as a projection with a flat surface. In either case, the higher surface pressure leads to this projection, as it were, digging into the brake carrier.

The arrangement of the projection can likewise differ. A known way of centering the guide bushing is to provide it at the end with an integrally formed collar which is fitted into a recess in the threaded hole of the brake carrier, while the annular contact surface, adjacent to the collar, of the guide bushing rests against the adjacent outer side of the brake carrier. The projection according to the invention is formed on the annular contact surface, either on the outer edge region or approximately in the middle of the contact surface.

Where the projection is designed as a ridge, i.e. with an encircling sharp edge, this ridge can be designed as an isosceles triangle in cross section or merely with a bevel. Here, the ridge, in conjunction with the screw preloading force, gives rise to a stress concentration radially on the outside, i.e. at the contact surface of the guide bushing and, by way of a lever arm with a maximum effect, a significant increase in the resistance torque in the direction of torsion with respect to a torque acting externally on the guide bar.

An increase in the resistance torque, similar to that in the taper seat of a drill chuck, is also obtained if the projection is designed as a sharp-edged ridge which plastically deforms the surface of the brake carrier by virtue of the screw preloading force.

It may furthermore be regarded as a particular advantage of the invention that the guide bushing can be implemented with a low outlay in terms of manufacture, and this is significant insofar as disc brakes are produced in large numbers as series-produced parts. The invention therefore meets the requirements for cost optimization to a high degree.

Among the contributing factors to this is the fact that the guide bushing according to the invention can be installed retroactively in already assembled brake carriers, and therefore a corresponding disc brake can be retrofitted, especially since no special machining of the brake carrier is required for this purpose.

The elimination of separate retention means, e.g. the wedge lock washers described with reference to the prior art, which is now possible, also leads to minimization of costs.

Further advantageous embodiments of the invention are characterized in the dependent claims.

Exemplary embodiments of the invention are described below with reference to the attached drawings.

### BRIEF DESCRIPTION OF THE DRAWINGS

FIG. 1 shows a brake carrier with installed guide bars in a sectioned perspective view;

FIG. 2 shows the connecting region of a guide bar to a brake carrier in a sectioned side view;

FIG. 3 shows an enlarged detail of the connecting region, corresponding to reference III in FIG. 2;

FIG. 4 and FIG. 5 each show different variant embodiments of the invention in a perspective view;

FIG. 6 shows another exemplary embodiment of the invention in the connecting region of the guide bar to a brake carrier; and

FIG. 7 shows the guide bushing according to FIG. 6 in a perspective view.

### DETAILED DESCRIPTION OF THE DRAWINGS

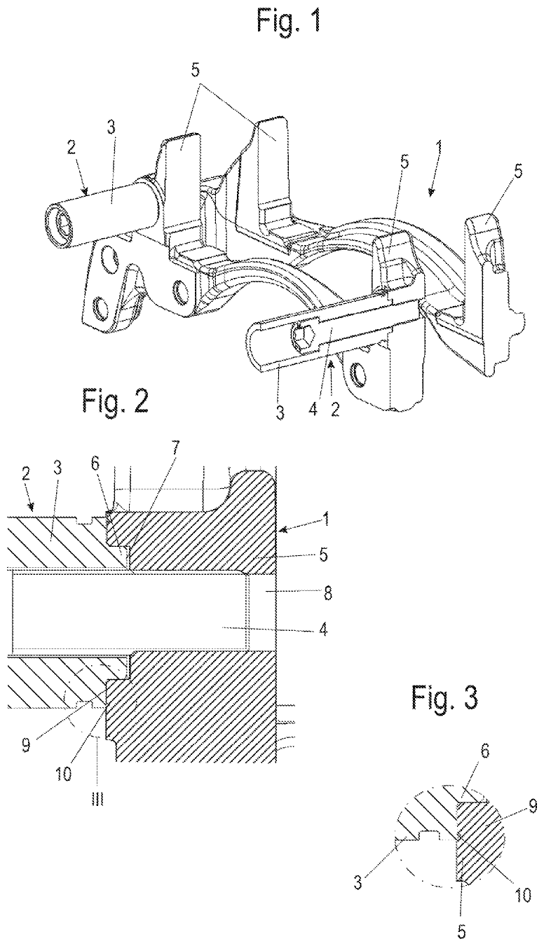

FIG. 1 illustrates a brake carrier 1, which is held in a fixed location on a vehicle while in operation and has mutually opposite brake carrier horns 5, against which brake pads (not shown) of a disc brake rest.

Guide bars 2 are secured on two brake carrier horns 5 situated opposite one another in alignment, for which purpose a screw 4 is passed through a cylindrical guide bushing 3 of the guide bar 2 and screwed into a threaded hole 8 (FIG. 2) in the associated brake carrier horn 5.

Mounted in an axially movable manner on these guide bars 2 is a brake caliper (not shown), which is also known as a sliding caliper.

The screw 4 used is preferably a hexagon socket screw, the head of which lies in a recess in the guide bushing 3.

On its end face facing the brake carrier 1, the guide bushing 3 has, as can be seen very clearly in FIG. 2, a collar 6 of relatively small diameter, which lies in a recess 7 of the threaded hole 8.

The end face of the guide bushing 3 facing the brake carrier horn 5, namely a contact surface 9 starting radially from the collar 6, has an encircling projection 10, designed as a ridge in the example, which is arranged in the radial end region of the contact surface 9 associated with the circumferential surface of the guide bushing 3.

In FIG. 3, the projection 10, which is triangular in cross section in the example, can be seen in an enlarged illustration, and it can also be seen that the projection 10 is pressed into the surface of the brake carrier horn 5, with the material of the brake carrier 1 being deformed.

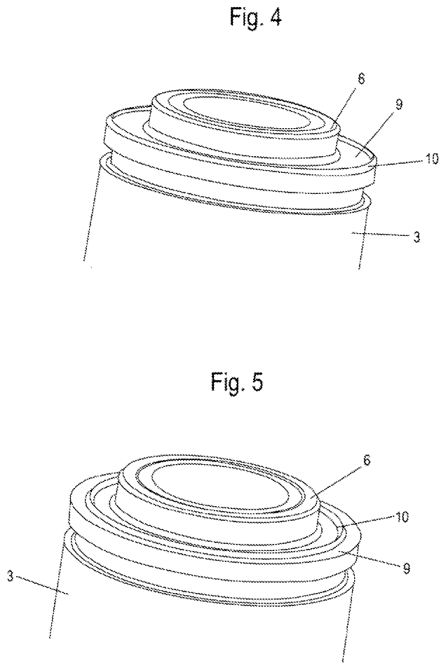

The example of the projection 10 shown in FIGS. 2 and 3 is depicted once again in FIG. 4, wherein the design of the projection 10 as a ridge is clearly visible.

In FIG. 5, which reproduces the end region of the guide bushing 3 provided with the projection 10, the projection 10 designed as a ridge is formed approximately in the middle of the radial contact surface 9.

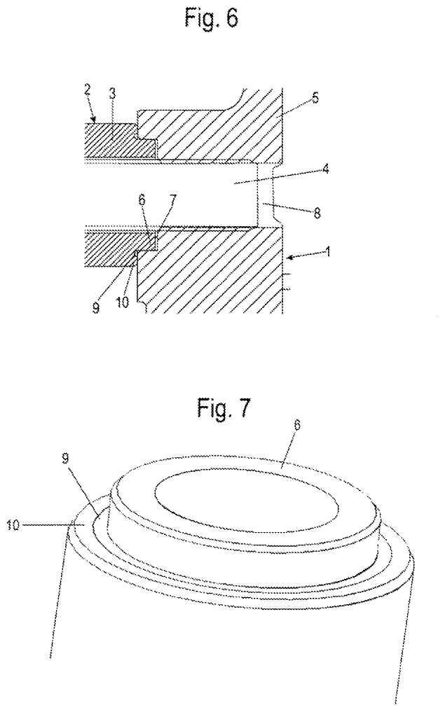

Another variant of the projection 10 can be seen in FIGS. 6 and 7, wherein FIG. 6 reproduces the connecting region of the guide bushing 3 to the brake carrier horn 5 in section. Particularly in FIG. 7, which shows a view comparable to FIGS. 4 and 5, it can be seen that the projection 10 has a flat shape arranged on the outer edge region of the contact surface 9, as a result of which a high surface pressure is achieved in the contact region of the projection 10 with the surface of the brake carrier horn 5.

### LIST OF REFERENCE SIGNS

1 brake carrier
2 guide bar
3 guide bushing
4 screw
5 brake carrier horn
6 collar
7 recess
8 threaded hole
9 contact surface
10 projection

1.-10. (canceled)

11. A disc brake for a utility vehicle, comprising:
a brake caliper which straddles a brake disc in use, and which is held movably on a stationary brake carrier by two guide bars, wherein
each guide bar has a guide bushing, which is connected to the brake carrier via a screw that is screwed into a threaded hole of the brake carrier, and which guide bushing is held in a rotationally secure manner on the brake carrier,
wherein
an end face of the guide bushing resting against the brake carrier has an encircling projection, which is pressed against an associated surface of the brake carrier.

12. The brake disc as claimed in claim 11, wherein
the projection is harder than material of the brake carrier.

13. The disc brake as claimed in claim 11, wherein
a contact surface of the guide bushing with the brake carrier, and the projection, are provided with at least one of:
a paste that increases the friction coefficient,
a coating that hardens, or
an insert that increases the friction coefficient.

14. The disc brake as claimed in claim 11, wherein
the projection is configured as a ridge.

15. The disc brake as claimed in claim 14, wherein
the ridge is triangular in cross section.

16. The disc brake as claimed in claim 11, wherein
the projection is provided on an edge region of a contact surface associated with a circumferential side of the guide bushing.

17. The disc brake as claimed in claim 11, wherein
the projection is provided approximately in a middle region of a contact surface associated with a circumferential side of the guide bushing.

18. The disc brake as claimed in claim 14, wherein
the ridge is configured as an isosceles or non-isosceles triangle in cross section.

19. The disc brake as claimed in claim 11, wherein
the projection has a flattened end surface.

20. The disc brake as claimed in claim 11, wherein
the guide bushing has, on the end face facing the brake carrier, a concentric collar, which projects relative to a radially adjoining contact surface extending toward the circumferential side of the guide bushing and is fitted into a recess in the brake carrier.
